(19) United States
(12) Patent Application Publication
(10) Pub. No.: US 2005/0142276 A1
(43) Pub. Date: Jun. 30, 2005

(54) Peanut spread

(75) Inventors: Alan John Slesinski, Denville, NJ (US); Earl Carroll Eichelberger, Warwick, NY (US); Richard Steven Wilkes, Edison, NJ (US); Christopher Burce Puno, Neshanic Station, NJ (US); Sonya Annette Whited, Piscataway, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 10/749,956

(22) Filed: Dec. 31, 2003

(51) Int. Cl. A23L 1/38

(52) U.S. Cl. 426/633

(57) ABSTRACT

A peanut or other nut spread with reduced levels of adjusted carbohydrates. The spread preferably includes peanuts, added peanut oil, added vegetable protein such as soy protein, and a stabilizer. An high intensity sweetener may also be included.

### BACKGROUND OF THE INVENTION

Peanut butter and other peanut spreads are widely enjoyed and find a variety of uses. The most common use of peanut butter is in preparing sandwiches. Other uses include dipping and eating the peanut butter with edible carriers such as crackers or vegetable pieces. To a lesser degree, peanut butter is used in a variety of baking and cooking applications. Product characteristics which are responsible for peanut butter's wide acceptance and popularity are its flavor, its good nutritional properties and its suitability for consumption alone or in combination with a variety of other foods.

Since common uses of peanut butter call for spreading, it is paramount that the product be of a soft consistency and be easily spreadable to avoid tearing bread or crumbling crackers. Additionally, since children are the largest group of peanut butter users, a soft and spreadable product will help to facilitate the application of peanut butter to bread, crackers and the like by this group without the need for assistance from parents. Consumers often prefer peanut spreads which are “creamy.”

Increasing attention has been paid recently to the excessive weight reportedly carried by many individuals and to the medical consequences thereof. Reports have associated excessive weight with a number of medical conditions, including heart disease and diabetes. For years a debate has raged as to which class of nutrients, fats or carbohydrates, are preferentially minimized to inhibit weight gain. Recently, much consumer attention has focussed on those who advocate reduction of carbohydrates and higher intakes of unsaturated fat and/or protein.

While peanut spreads tend to be relatively low in carbohydrates, in view of the recent focus by many on minimization of carbohydrate intake, it would be desirable to reduce further the level of carbohydrates in such products. Unfortunately, consumers show little inclination to sacrifice organoleptic properties in their favorite foods. Therefore, low carbohydrate products should have good organoleptic properties similar to their full carbohydrate cousins.

Much of the peanut butter literature focuses on achieving good spreadability and mouth feel, avoiding oil separation, and reducing fat or total calorie content.

Traska et al., U.S. Pat. No. 5,202,147 is directed to a method of preparing a whipped peanut butter. In example 1, 872 pounds of peanuts are combined with 12.8 pounds of other ingredients.

Wong, U.S. Pat. No. 6,063,430 concerns peanut butter compositions comprising a blend of mono-modal and multi-modal compositions. The blended peanut butter is said to have a relatively low viscosity, yet avoid an oily appearance and greasy mouth feel. The Wong invention is directed to the discovery that by blending a nut butter having a monomodal particle size distribution with a nut butter having a multi modal particle size distribution, the blended nut butter can have a creamy texture and good peanut flavor yet avoid an oily appearance and greasy mouthfeel.

Wong's nut spreads comprise about 25% to about 60% nut solids, about 4 to about 12% added oil, about 42 to 60% total fat, from about 3.5 to about 25% water soluble solids, and nut butter stabilizer at up to about 5%. Sugars are included at from about 0.5 to about 10%. Artificial sweeteners such as aspartame, acesulfam, saccharine, cyclamate and glycerrhizin can also be used, usually at from about 0.001% to about 2%. Soy flour, soy isolate and soy concentrate, or protein from other vegetable and from animal sources, and any combination thereof, can be used. It is said to be desirable to add the water soluble solids first and then protein, e.g., soy protein, to keep the protein from denaturing. Example 1 includes 83.55% peanuts, 6.3% sugar, 6.45% added peanut oil, 0.9% salt, 0.5% molasses, 2.1% stabilizer and 0.2% emulsifier.

Wong indicates that his nut spreads can be prepared starting with a nut paste and added oil in a mixing tank. Other nut spread ingredients such as sugars, protein solids, stabilizer and emulsifier are mixed in. Water soluble solids should be added first, before protein solids. The mixture is then typically homogenized.

Wong et al., U.S. Pat. No. 5,079,027 discloses a preferably reduced fat nut butter spread composition having 5.8% sucrose, 0.5% molasses, 73.83% peanut cake (25% fat basis) and 17.16% peanut oil. Stabilizers are said usually to be added at from 0.5% to 3% by weight. Various ranges for possible ingredients are given. Artificial sweeteners may be included at levels which would provide the equivalent of from about 1% to about 7% of sucrose.

Fix et al., U.S. Pat. No. 5,714,193 is directed to peanut butter spreads having a low viscosity of 2000 centipoise or less but which maintain desired nut flavor intensity. The spreads are obtained by high shear mixing of nut paste plus oil.

Meade, U.S. Pat. No. 6,010,737 is directed to a reduced fat and reduced calorie nut butter composition. The composition is said not to have a high viscosity. A stabilizer is generally employed at from 0.5 to 3.5%, preferably 0.5-2%. In Example 1, the peanut butter had a soft, spreadable texture. Among the ingredients included in the compositions are included partially defatted peanuts and peanut flour, Salatrim, sugar, polydextrose, inulin and stabilizer.

Japikse et al. U.S. Pat. No. 4,288,378 discloses a peanut butter formula.

Smuckers markets a peanut spread which includes little or no added sugar.

Particularly in view of the recent attention paid to carbohydrate reduction, there is still a need for peanut butter spreads which are neatly and easily applied and which have reduced levels of carbohydrates.

### SUMMARY OF THE INVENTION

The present invention is directed to the discovery of a peanut spread which has fewer carbohydrates, on an adjusted basis, than the typical spreads yet retains the desirable mouthfeel properties of full-carbohydrate peanut spreads. In particular, the spread is creamy notwithstanding the decrease in carbohydrates. In a first aspect then, the invention is directed to a nut spread including nuts, and added vegetable oil, the nut spread having 3.5 grams or fewer of total adjusted carbohydrate per 2 tablespoon serving. By “adjusted carbohydrate” herein is meant the total carbohydrate in the indicated food or ingredient minus the total dietary fiber and sugar alcohol in that food or ingredient on a per serving basis. By some reports, adjusted carbohydrates is a better measure of any negative effects of ingested carbohydrate than total carbohydrate; for instance, dietary fiber is thought to be beneficial.

The nut spreads of the invention preferably have 3.5 grams or fewer of adjusted carbohydrate per two tablespoon serving, especially from 1-3 grams of adjusted carbohydrate per two tablespoon serving. Preferably the nuts comprise peanuts and the vegetable oil comprises peanut oil, soy, canola or other suitable oil.

The spread of the invention may include fewer nuts than in many prior nut spreads. Preferably the spread comprises up to 80% nuts, especially from 40 to 70% nuts, and typically from 50 to 65% nuts. The added vegetable oil will generally comprise 10-30%, especially from 15 to 25% of the spread.

In accordance with a particularly preferred aspect of the invention, the nut spreads include from 2-15% added protein, especially non-peanut protein, and most especially soy protein. Still preferably, the level of added soy or other vegetable protein ranges from 8-14% added non-peanut protein, especially 10-12%.

Unless otherwise required by context, by “added” we distinguish ingredients such as protein, vegetable oil and sweeteners from protein, oil and sugar present inherently in the peanuts which are incorporated into the product, for example as peanuts or in a slurry or paste or other processed form.

The nut spread of the invention can include a high intensity sweetener if so desired to improve its flavor and reduce or eliminate the need for sugars and other carbohydrate-loaded sweeteners. Preferably, the level of high intensity sweetener, if present, is from 0.005 to 1 wt %.

The products of the invention are generally not low in fat compared to other peanut spreads. The total fat, counting all ingredients, will generally be 40% or greater, especially 45% or greater and most likely 50% or greater.

For a more complete understanding of the above and other features and advantages of the invention, reference should be made to the following detailed description of preferred embodiments and to the accompanying drawings.

### BRIEF DESCRIPTION OF THE DRAWING

FIG. 1 is a diagram of a process for making the product of the invention.

### DETAILED DESCRIPTION OF THE INVENTION

The term “peanut spread” as used herein includes, but is not necessarily limited to, “peanut spreads” as defined in US FDA regulations as of Jan. 1, 2003. As used herein, peanut spread means a spreadable product having at least 40% peanut ingredients, which can be added in various forms, e.g., as nuts, a paste and/or a slurry. The percent by weight of peanuts in the present product can range especially from 55 to 80%, especially 60-75% and higher for standard peanut butters.

The total level of triglycerides in the peanut spreads of the invention, including triglycerides from peanuts, will preferably range from 45-60 wt %, esepcially from 54 to 60 wt %.

The peanut or other nut spread of the invention may include high melting vegetable oil stabilizers at a level of from 0.5 to 10 percent, preferably from 1 to 5%. The high melting (145°-155° F.) vegetable oil stabilizer is especially of palm, soy, cottonseed and similar vegetable oil origins. The stabilizer tends to reduce liquid oil separation and to improve the viscosity of the product.

To the extent consistent with the goal of minimizing adjusted carbohydrates, appropriate seasoning ingredients for the peanut spread include the following and combinations thereof: salt, honey, maple syrup, and molasses, liquid or powdered. Seasonings may constitute from 0 to 5%, especially 0.5 to 5%. Levels of ingredients which serve primarily as sweeteners or vegetable oils, which might by some definitions also be considered seasonings or stabilizers, are provided elsewhere herein.

The spread of the invention will generally include added protein, i.e., protein added in addition to protein inherent in the peanuts. The preferred protein source is soy and other non-peanut vegetable sources. Other sources of protein include sources of whey protein such as whey protein isolate and whey protein concentrate and sources of rice protein such as rice flour and rice protein concentrate. Additional protein sources include one or more of dairy protein sources, such as whole milk, skim milk, condensed milk, evaporated milk, whey, milk solids non-fat, etc. The dairy source may contribute dairy fat and/or non-fat milk solids such as lactose and milk proteins, e.g. whey proteins and caseins. Protein concentrates such as one or more of whey protein concentrate, milk protein concentrate, caseinates such as sodium and/or calcium caseinate, isolated soy protein and soy protein concentrate may be used. Total protein levels within the spreads of the invention are preferably within the range of 20 wt. % to 28 wt. %, such as from 22 wt. % to 26 wt. %, especially from 24-26%.

A suitable source of soy protein the protein concentrate sold as ARCON F by ADM.

Added sweeteners used in the present invention, whether or not artificial, may be high intensity sweeteners, i.e., sweeter than sucrose. High intensity sweeteners vary in their relative sweetness to sucrose. Some sweeteners have been reported to be 20,000 times as sweet as sucrose, but typically are 200-1000 times sweeter than sucrose. Very low amounts of these sweeteners may be sufficient to achieve the same sweetness level that would be found in product using traditional sweeteners, such as sucrose. These high intensity sweeteners may or may not contain carbohydrates. However, when used at low levels, their effect is negligible on the total carbohydrate level and adjusted carbohydrate level of the finished peanut spread.

If it is desired to use high intensity sweeteners, any of the high intensity sweeteners, which can be natural or artificial, typically artificial, may be used. These high intensity sweeteners include those well known in the art, such as aspartame, saccharine, Alitame® (obtainable from Pfizer), acesulfame K (obtainable from Hoechst), cyclamates, neotame, sucralose, mixtures thereof and the like. Amounts of these sweeteners will vary depending on the relative intensity of the chosen sweetener and the desired sweetness level of the finished spread.

In view of the goal of minimizing carbohydrates, it may be desirable to limit any carbohydrate containing sweeteners, whether artificial or natural, to high intensity sweeteners. However, modest amounts of carbohydrate containing sweeteners, whether natural or artificial, may be included provided that excessive carbohydrates are not present in the spread. Carbohydrate-containing sweeteners include sucrose (liquid or solids), glucose, fructose, medium invert and invert sugars and corn syrup (liquid or solids), including high fructose corn syrup and high maltose corn syrup, dextrose and mixtures thereof. Other sweeteners include lactose, maltose, brown sugar and galactose and mixtures thereof. Sweeteners, such as fructose, that are moderately sweeter than sucrose, can be used alone or in combination with other sweeteners, whether high-intensity or not, to achieve sweetness in the final spread, while minimizing the total level of added carbohydrates. Total sweeteners other than sugar alcohol and fibers, alone or in combination are preferably added, if at all, at up to 6 wt %, especially 0.5 to 3%. In particular, added sugars should not exceed 6 wt % and should be added, if at all, at up to 6%, especially from 0.5 to 3%.

In accordance with the invention, one or more sugar alcohols could be used to replace soy protein concentrate or other no/low adjusted carb components, and achieve the same or better adjusted carbohydrate targets. Sugar alcohols include, without limitation, glycerol, inositol, mannitol, erythritol, lactitol, sorbitol, xylitol and alpha methylglucoside. If desired, the peanut spread may have sugar alcohols at a level of from 1% to 6%.

If desired, the peanut spread may have an emulsifier at a level of from 0.1% to 0.5%, especially from 0.2 to 0.4%. Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Mono- and di-glycerides are preferred. Emulsifiers may be used in combination, as appropriate.

If desired, bulking agents such as Avicel brand microcrystalline cellulose, other forms of dietary fiber, sugar alcohols or protein may be used. Preferably the bulking agents are the source for minimal or no adjusted carbohydrates.

It may be desirable to include flavorings, such as natural or artificial peanut flavor(s) in the spread of the invention. Suitable flavorants may also include seasoning, such as salt, as indicated above.

The mixture of peanuts, seasonings and stabilizers may be ground into a fine paste for example via the use of milling equipment which is standard in the peanut butter industry, such as a Bauer and/or an Urshel mill. The milled peanut butter paste may be collected in a standard feed or supply tank fitted with a vacuum system to de-aerate the milled paste from any entrapped or entrained atmospheric air. It may also be de-aerated prior to milling.

Generally, the composition of the invention will include peanut oil. Optionally as supplement and to boost further the flavor intensity, a high flavor peanut oil may be used in this invention. The high flavor peanut oil is obtained by the extraction of oils from dark roasted peanut. As example of a high flavor peanut oil suitable for use herein is the high flavor peanut oil extracted from dark roasted peanuts supplied by Food Materials Corp., Chicago, Ill. 60618. The high flavored peanut oil may be added at levels of 0.5 to 3.0%, in addition to any other peanut or vegetable oil present in the composition. Also, dark roasted peanut paste may be used.

Further edible components may be included if they can be used consistent with the carbohydrate minimization goals of the invention. Typically, these will be ingredients which are not within the Standard of Identity for peanut butter or peanut spread. Such further edible components which may be added to the nut or other butters or other products include jelly, chocolate and marshmallow filling. The jelly may be any flavor, such as grape or strawberry jelly. Preferably, if these items are included, they are included in the form of low carbohydrate variants of the product, e.g., low carbohydrate jelly, chocolate, etc.

Further edible components may be fillings or particulates. Fillings can be defined as sweet or savory food mixtures used to fill pastry, cake or sandwiches. Examples of fillings/filling components include: nut pieces, fruit, chocolate, jams/jellies, apricot, cherry, blueberry, guava, lemon, mango, raspberry, strawberry, papaya, marshmallow and banana. Often fillings will include a gel material such as a pectin. Gum bases, such as guar, are common. The filling will generally be low in water. Fillings generally impart flavor/and or solids and/or texture to the food. Again, filings or particulates should be used only to the extent consistent with the carbohydrate reduction goals of the product and preferably in the form of low carb fillings versions of the particulates.

The further edible components may also be particulates, such as graham, puffed rice and chocolate morsels. Particulates may impart texture and/or flavor and/or solids to the food.

For some further edible components which may be mixed with the peanut spread, it is important to consider the water activities of the further edible component and the nut butter.

The further edible components, e.g., filling, may be used at levels of, say, 15-50 wt. % of the combined nut spread and filling. The further edible components may be combined in patterns wherein the peanut spread and the further edible component, e.g., jelly or other filling are mixed in discrete portions discernable to the consumer. For instance, the jelly or jam can be present in swirls.

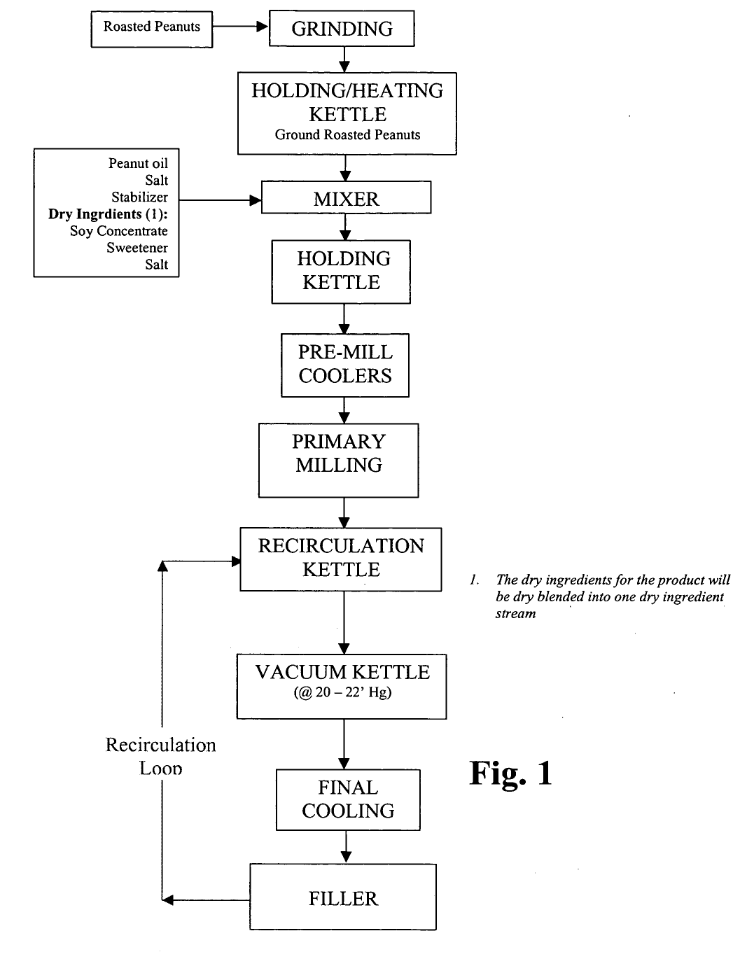

The nut spread of the invention may be prepared using the following procedure (the Preparation Procedure) illustrated in FIG. 1:

a) Roasted full fat nuts are sorted and ground into a course paste using a mill such as a Bauer mill,

b) Ground roasted full fat nuts are heated, if necessary, to a temperature above the melting point of the given stabilizer, for example to 145° F., especially 155-160° F. or above.

c) The remaining ingredients are added to the heated slurry in accordance with the formulation and thoroughly mixed.

d) the peanut mixture is cooled to 125° F. and then fed into the primary milling operation Urschel Mill

e) The mixture emerges from the Urschel Mill at 165-170° F.

f) the milled composition is deaerated using a Versater or vacuum kettle

g) the resulting peanut spread is a creamy product.

h) The creamy product is cooled to approximately 80° F. in the final scrape surface heat exchangers and filled into jars.

### EXAMPLES

The following products are made using the process described above.

### Example 1

| Ingredient | | Level % |
|---|---|---|
| Peanut Oil | Food Materials Corp. | 22.98 |
| Ground Roasted Peanuts | | 65.00 |
| Stabilizer | Sta-Set FR, Loders Croklaan | 1.80 |
| Sweetener | Sucralose, McNeil Nutritionals | 0.01 |
| Microcrystalline Cellulose | Avicel LM 310, FMC BioPolymer | 1.00 |
| Soy Prot. Concentrate | Arcon F, ADM Protein Specialties | 8.00 |
| Salt | | 1.21 |
| Total % | | 100.00 |

The product is an acceptable, relatively soft peanut spread. In this example, peanuts with a fat content of 49.7%, protein content of 23.7%, total carbohydrate of 21.5%, and fiber of 8.0% would result in a peanut spread with a fat content of 57.3%, protein content of 20.9%, total carbohydrate of 16.6%, and fiber of 7.7%. A two-tablespoon serving, weighing approximately 31 grams, results in a adjusted carbohydrate level of 2.7 grams.

### Example 2

| Ingredient | | Level % |
|---|---|---|
| Peanut Oil | Food Materials Corp. | 20.88 |
| Ground Roasted Peanuts | | 64.00 |
| Stabilizer | Sta-Set FR, Loders Croklaan | 1.90 |
| Sweetener | Sucralose, McNeil Nutritionals | 0.01 |
| Microcrystalline Cellulose | Avicel LM 310, FMC BioPolymer | 0.00 |
| Soy Prot. Concentrate | Arcon F, ADM Protein Specialties | 12.00 |
| Salt | | 1.21 |
| Total % | | 100.00 |

The product is an acceptable, firmer peanut spread. In this example, peanuts with a fat content of 49.7%, protein content of 23.7%, total carbohydrate of 21.5%, and fiber of 8.0% would result in a peanut spread with a fat content of 54.9%, protein content of 23.5%, total carbohydrate of 16.2%, and fiber of 7.4%. A two-tablespoon serving, weighing approximately 31 grams, results in a adjusted carbohydrate level of 2.7 grams.

Percentages herein are given by weight unless explicitly stated otherwise or clearly required by context.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A nut spread comprising:
a) nuts, and
b) added vegetable oil,
c) said nut spread having 3.5 grams or fewer of total adjusted carbohydrate per 2 tablespoon serving.

2. The nut spread according to claim 1 having 3 grams or fewer of adjusted carbohydrate per serving.

3. The nut spread according to claim 1 having 2.5 grams or fewer of adjusted carbohydrate per serving.

4. The nut spread according to claim 1 wherein said nuts comprise peanuts.

5. The nut spread according to claim 1 wherein said vegetable oil comprises peanut oil.

6. The nut spread according to claim 1 comprising up to 80% nuts.

7. The nut spread according to claim 6 comprising from 40 to 70% nuts.

8. The nut spread according to claim 7 comprising from 50 to 65% nuts.

9. The nut spread according to claim 1 comprising from 10-40% of said added vegetable oil.

10. The nut spread according to claim 9 comprising from 15 to 35% of said added vegetable oil.

11. The nut spread according to claim 1 further comprising from 2-15% added non-peanut protein.

12. The nut spread according to claim 11 further comprising from 3-8% added non-peanut protein.

13 The nut spread according to claim 11 wherein said added protein is soy protein.

14. The nut spread according to claim 1 further comprising a high intensity sweetener.

15. The nut spread according to claim 14 wherein said high intensity sweetener is present at a level of from 0.005 to 1 wt %.

16. The nut spread according to claim 1 wherein said spread has a total of 40% or greater fat.

17. The nut spread according to claim 16 wherein said spread includes a total of 45% or greater fat.

18. The nut spread according to claim 18 wherein said spread includes a total of 50% or greater fat.

19. A nut spread comprising:
a) nuts, and
b) added vegetable oil,
c) a sweetener selected from the group consisting of sugar alcohols and high intensity sweeteners,
c) said nut spread having 3 grams or fewer of total adjusted carbohydrate per 2 tablespoon serving.

20. A nut spread comprising:
a) nuts, and
b) added vegetable oil,
c) a high intensity sweetener,
d) said nut spread having 3.5 grams or fewer of total adjusted carbohydrate per 2 tablespoon serving.

21. The nut spread according to claim 20 wherein said nut spread has 3.5 grams or fewer of total adjusted carbohydrate per 2 tablespoon serving.

22. The nut spread according to claim 21 wherein said nut spread has 3 grams or fewer of total adjusted carbohydrate per 2 tablespoon serving.

23. A nut spread comprising:
a) nuts, and
b) added vegetable oil,
c) any added sweetener other than sugar alcohol and fibers not exceeding 6 wt %,
d) said nut spread having 3.5 grams or fewer of total adjusted carbohydrate per 2 tablespoon serving.

24. The nut spread according to claim 23 wherein total added sweeteners other than sugar alcohol and fibers are present at 0.5 to 3%.
